(19) United States
(12) Patent Application Publication
(10) Pub. No.: US 2014/0125939 A1
(43) Pub. Date: May 8, 2014

(54) Eyeglass Frame With Temple Region For Interchangeable Ornaments

(71) Applicant: Patrick C. Ho, Hilton, NY (US)

(72) Inventor: Patrick C. Ho, Hilton, NY (US)

(21) Appl. No.: 13/746,820

(22) Filed: Jan. 22, 2013

Related U.S. Application Data
(60) Provisional application No. 61/724,021, filed on Nov. 8, 2012.

(51) Int. Cl. G02C 11/02

(52) U.S. Cl. CPC G02C 11/02
USPC 351/52

(57) ABSTRACT

An eyeglass frame includes a pair of temple arms thereon, each temple arm having an ornament mounting area disposed along a temple region of the frame and a first end of the mounting area and a second end of the mounting area spaced apart from the first end; each temple arm having a diameter dimension of a size sufficient to fit through a hole opening of a detachable ornament, wherein each ornament mounting area is configured to detachably secure the ornament thereon.

### CROSS-REFERENCE TO RELATED APPLICATIONS

This application claims priority from U.S. Provisional Application Ser. No. 61/724,021 filed Nov. 8, 2012 and entitled EYEGLASS FRAME WITH TEMPLE REGION FOR INTERCHANGEABLE ORNAMENTS, incorporated herein by reference

### BACKGROUND OF THE INVENTION

1. Field of the Invention

The present invention relates to an eyeglass frame in which interchangeable ornaments can be detachably secured to the temple region of the frames. In particular, the eyeglass frame has a temple region ornament mounting area.

2. Description of the Related Art

Eyewear having interchangeable ornaments positioned on the eyeglass frame in any number of ways is well known in the prior art. Many women today enjoy the individual expression that is brought about by accessorizing various personal items of clothing and jewelry.

However, the art lacks the ability to provide an eyeglass frame in which interchangeable ornaments can be detachably secured to the temple region of the frames and readily matched to other accessories.

### SUMMARY OF THE INVENTION

In accordance with one aspect of the present invention, there is provided an eyeglass frame having a pair of temple arms thereon, each temple arm having an ornament mounting area disposed along a temple region of the frame; each ornament mounting area having a first end of the mounting area and a second end of the mounting area spaced apart from the first end; each temple arm having a diameter dimension of a size sufficient to fit through a hole opening of a detachable ornament, wherein each mounting area is configured to detachably secure the ornament thereon.

These and other aspects of the present invention will become apparent upon a review of the following detailed description and the claims appended thereto.

### BRIEF DESCRIPTION OF THE DRAWINGS

FIG. 1 is a perspective view of the eyeglass frame of the present invention with detachable ornaments mounted thereon in the temple region of the frame;

FIG. 2 is a perspective view of the eyeglass frame of the present invention without detachable ornaments mounted thereon showing the first end and second end of the ornament mounting area of the temple arms;

FIG. 3 is a perspective view of a temple arm of the eyeglass frame showing an embodiment of the ornament mounting area of the temple arm of the present invention;

FIG. 3A is a telescoping perspective view of a detachable ornament having a hole opening therein slidably inserted onto a temple arm;

FIG. 4 is a perspective view of a temple arm of the eyeglass frame showing an embodiment of the ornament mounting area having a loosely fit detachable ornament mounted thereon;

FIG. 5 is a perspective view of a temple arm of the eyeglass frame showing an embodiment of the ornament mounting area having a detachable ornament clamping to an end of the temple arm mounting area of the present invention; and

FIG. 6 is a perspective view of a temple arm of the eyeglass frame showing an embodiment of the ornament mounting area of the temple arm of the present invention.

### DETAILED DESCRIPTION OF PREFERRED EMBODIMENTS

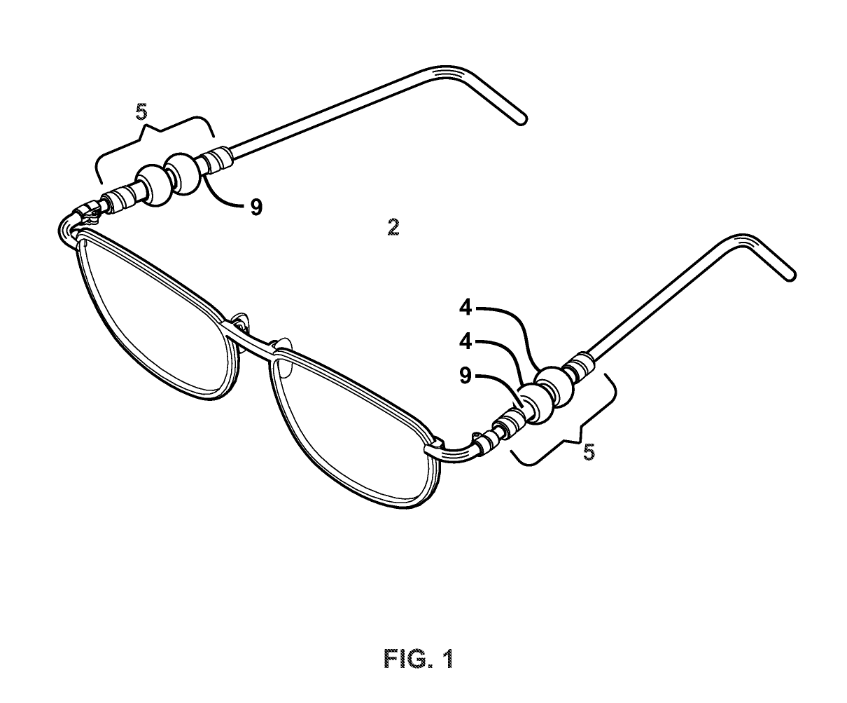

FIG. 1 is a perspective view of the eyeglass frame 2 of the present invention with a plurality of detachable ornaments 4 detachably secured to each ornament mounting area 9 in the temple region 5 of the frame 2. The temple region is that region of the frame near the wearer's temple where ornaments can be mounted to the frame in accordance with the present invention and preferably the ornaments do not touch the wearer's face. A detachable ornament is preferably any ornament that can be mounted to the frame. The eyeglass frame can also include sunglasses.

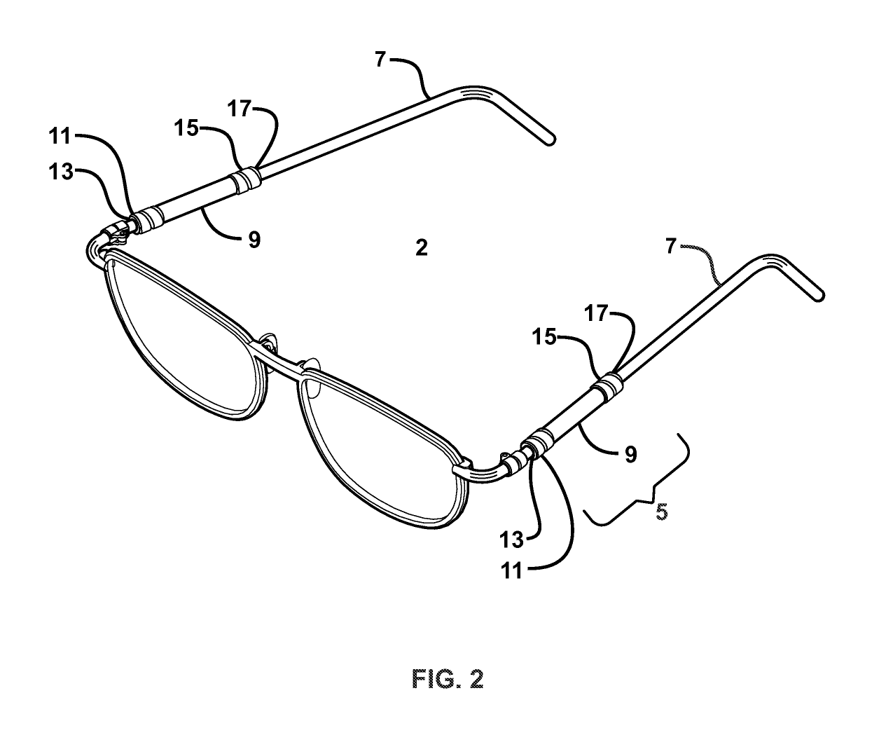

Referring to FIG. 2, the eyeglass frame 2 of the present invention includes a pair of temple arms 7 thereon. Each temple arm 7 has an ornament mounting area 9 disposed along a temple region 5 of the frame 2. Each ornament mounting area 9 has a first end 13 of the mounting area 9 and a second end 17 of the mounting area 9 spaced apart from the first end 13.

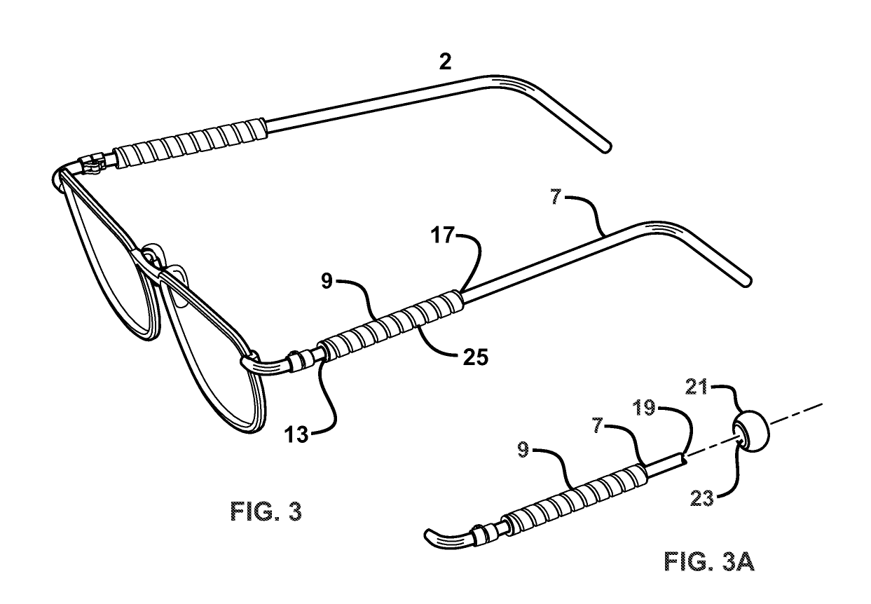

As shown in FIG. 3, an embodiment of the temple arm 7 has an ornament mounting area 9 with a male thread 25 extending between the first end 13 and the second end 17 having a diameter of a size sufficient to secure thereon by threading a plurality of ornaments having a hole opening therein with a corresponding female thread (not shown). As shown in more detail in FIG. 3A, each temple arm 7 has a diameter dimension 19 of a size sufficient to fit through the hole opening 23 of a detachable ornament 21. Each ornament 21 has a hole opening 23 therein, preferably with a corresponding female thread. The hole opening 23 has a diameter greater than the diameter dimension 19 of the temple arm 7 and can be slideably inserted onto the temple arm 7 and threaded onto mounting area 9, as shown in FIG. 3A. As shown in FIGS. 3 and 3A, the mounting area 9 is configured to detachably secure the ornament 21 thereon.

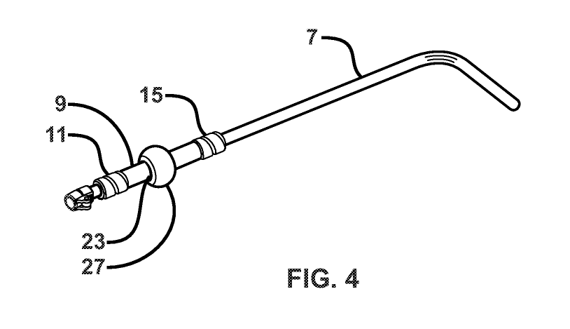

Referring to FIG. 4, an embodiment of the temple arm 7 has an ornament mounting area 9, wherein the diameter of ornament mounting area 9 between the first thread 11 and second thread 15 has a size sufficiently smaller than the diameter of the hole opening 23 of ornament 27. In this embodiment, ornament 27 can be detachably secured thereon between the first thread 11 and the second thread 15 in a loosely fit manner while being free to jiggle.

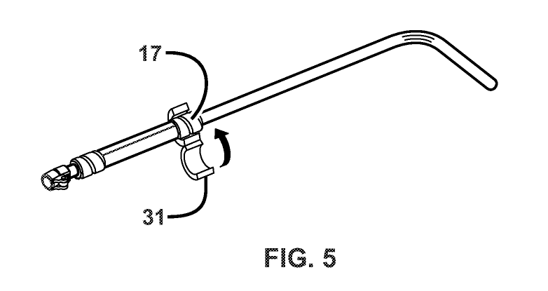

Referring to FIG. 5, an ornament 31 is shown capable of clamping onto an end of the ornament mounting area, preferably the second end 17, as shown, such that the ornament 31 is detachably secured to the end of the ornament mounting area.

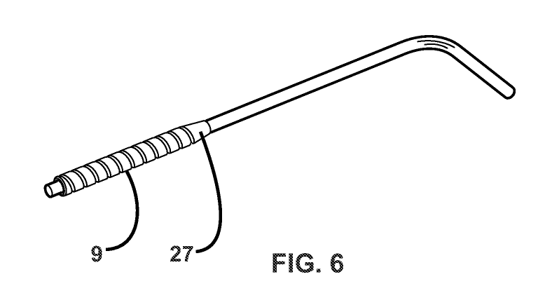

Referring to FIG. 6, an embodiment of the temple arm 7 has an ornament mounting area 9 with a tapered end 27 for ease of inserting a plurality of ornaments thereon.

While the invention has been described with preferred embodiments, it is to be understood that variations and modification are to be considered within the purview and scope of the claims appended hereto.

What is claimed is:

1. An eyeglass frame comprising:
a pair of temple arms thereon, each temple arm comprising an ornament mounting area disposed along a temple region of the frame;
each ornament mounting area comprising a first end of the mounting area and a second end of the mounting area spaced apart from the first end;
each temple arm having a diameter dimension of a size sufficient to fit through a hole opening of a detachable ornament, wherein each ornament mounting area is configured to detachably secure the ornament thereon.

2. The eyeglass frame of claim 1, further comprising one or a plurality of ornaments detachably secured to at least one ornament mounting area.

3. The eyeglass frame of claim 1, further comprising an ornament with a hole opening having a female thread and wherein the ornament mounting area comprises a corresponding male thread, wherein the ornament is detachably secured to the ornament mounting area by the male and female threads.

4. The eyeglass frame of claim 1, wherein the ornament mounting area comprises a male thread diameter of a size sufficient to secure thereon a plurality of ornaments each with a hole opening having a corresponding female thread.

5. The eyeglass frame of claim 1, wherein the ornament mounting area between the first end and second end has a diameter of a size sufficiently smaller than the hole opening diameter of each of a plurality of ornaments each detachably secured thereon such that the ornaments are loosely fit and free to jiggle.

6. The eyeglass frame of claim 1, further comprising an ornament capable of clamping onto an ornament mounting area end that the ornament is detachably secured to the ornament mounting area.
